(19) United States
(12) Patent Application Publication
(10) Pub. No.: US 2014/0269145 A1
(43) Pub. Date: Sep. 18, 2014

(54) CHARGE HOPPER ASSEMBLY

(71) Applicant: OSHKOSH CORPORATION, Oshkosh, WI (US)

(72) Inventors: Dale J. Fasana, Oshkosh, WI (US); Richard R. Kotloski, Oshkosh, WI (US)

(73) Assignee: OSHKOSH CORPORATION, Oshkosh, WI (US)

(21) Appl. No.: 13/802,308

(22) Filed: Mar. 13, 2013

(51) Int. Cl. B28C 5/42

(52) U.S. Cl. CPC B28C 5/4237
USPC 366/41

(57) ABSTRACT

A concrete mixer includes a chassis, a cab coupled to the chassis, and a mixing drum rotatably coupled to the chassis and defining an opening. The concrete mixer also includes a charge hopper assembly positioned at the opening of the mixing drum. The charge hopper assembly includes a latch, an actuator coupled to the latch and positioned to move the latch between a first position and a second position, and a sensor positioned on the latch and configured to indicate the orientation of the latch and the charge hopper assembly.

### BACKGROUND

The present application relates generally to concrete mixer trucks for mixing, transporting, and discharging concrete. In particular, the present application relates to charge hopper assemblies for such trucks.

Concrete can be mixed and poured from vehicles or from stationary facilities, such as concrete mixing plants. Concrete vehicles or trucks are commonly employed in construction to mix, transport, and pour concrete. Such trucks can be rear discharge concrete vehicles or front discharge concrete vehicles. Rear discharge concrete vehicles generally feature a drum with an outlet positioned at an aft end of the truck and a cab enclosure positioned at the fore end. Front discharge concrete vehicles include a drum with an outlet supported above a cab enclosure of the vehicle to discharge concrete through a chute extending forward the vehicle. Because such vehicles discharge concrete at the forward end, they can be used to supply concrete to locations having limited access. Both types of vehicles can be equipped with charge hopper assemblies. One function of a charge hopper assembly is to introduce inorganic materials into a drum of the truck. Another function of the charge hopper assembly is to prevent loss of material or spillage when the material enters the drum.

Charge hopper assemblies include hoppers that rotate upward. Hoppers that rotate upward increase the height of the truck and may not be suitable for concrete mixer trucks that operate in height-limited spaces. When raised, such hoppers may increase the total height of the vehicle by several feet. Furthermore, conventional charge hopper assemblies that swing the hopper vertically must overcome significant gravitational forces as the hoppers of such assemblies have considerable weight (e.g., several hundred pounds). Moreover, swinging the hopper vertically requires a lifting mechanism to raise and lower the hopper.

### SUMMARY

One exemplary embodiment of the invention relates to a concrete mixer that includes a chassis, a cab coupled to the chassis, and a mixing drum rotatably coupled to the chassis and defining an opening. The concrete mixer also includes a charge hopper assembly positioned at the opening of the mixing drum. The charge hopper assembly includes a latch, an actuator coupled to the latch and positioned to move the latch between a first position and a second position, and a sensor positioned on the latch and configured to indicate the orientation of the latch and the charge hopper assembly.

Another exemplary embodiment of the invention relates to a charge hopper assembly for a vehicle having a platform that includes a first support member coupled to a first lateral side of the platform, a second support member coupled to a second lateral side of the platform, a hopper coupled to the first support member and configured to direct material into a mixing drum, and a latch coupled to the second support member and movable between a first position and second position. The latch secures the hopper to the second support member when in the second position. The charge hopper assembly also includes an actuator coupled to the latch and configured to move the latch between the first position and the second position and a sensor positioned on the latch and configured to indicate the position of the latch and the charge hopper assembly. The charge hopper assembly rotates to a side of the platform such that the charge hopper assembly inhibits access to an opening of the mixing drum.

Still another exemplary embodiment relates to a superstructure for a concrete truck that includes a support and a charge hopper assembly coupled to the support. The support is configured to be coupled to a first lateral side of the concrete truck that provides operator access. The charge hopper assembly includes a first support member coupled to the first lateral side of the support, a second support member coupled to an opposing lateral side of the support, and a charging chute for receiving materials. The charging chute is rotatably coupled to the first support member with a pivot such that the charging chute rotates toward the first lateral side of the concrete truck.

The invention is capable of other embodiments and of being carried out in various ways. Alternative exemplary embodiments relate to other features and combinations of features as may be generally recited in the claims.

### BRIEF DESCRIPTION OF THE FIGURES

The invention will become more fully understood from the following detailed description taken in conjunction with the accompanying drawings wherein like reference numerals refer to like elements, in which:

FIG. 1 is a side plan view of an exemplary embodiment of a concrete truck with a charge hopper assembly;

FIG. 2 is a left side isometric view of an exemplary embodiment of a charge hopper assembly in which the hopper is closed;

FIG. 3 is a left side isometric view of an exemplary embodiment of a charge hopper assembly in which the hopper is open;

FIG. 4 is a right side isometric view of an exemplary embodiment of a charge hopper assembly in which the hopper is open;

FIG. 5 is a front view of an exemplary embodiment of a charge hopper assembly;

FIG. 6 is a right side view of an exemplary embodiment of a charge hopper assembly;

FIG. 7 is a left side view of an exemplary embodiment of a charge hopper assembly;

FIG. 8 is a top view of an exemplary embodiment of a charge hopper assembly with a closed hopper; and

FIG. 9 is a top view of an exemplary embodiment of a charge hopper assembly with an open hopper.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

A concrete mixing truck may include a charge hopper assembly with a hopper, a chute for directing materials, and funneling systems having elements that allow for movement about either a vertical or horizontal axis. Hoppers may be fixed or may have freedom of movement to allow swinging towards a loading point. Fixed hoppers suffer from difficulties in discharging material efficiently, particularly low-slump materials.

The exemplary embodiments of the charge hopper assembly limit operator access to the mixing drum by rotating toward a mixing drum access point, blocking access. In one embodiment, the concrete mixer truck includes a superstructure positioned at an end of the mixing drum. According to an exemplary embodiment, the hopper swings toward an access side of the superstructure thereby restricting access to the superstructure and the opening of the mixing drum. Such a hopper swings to the side about a vertical axis and does not increase the overall height of the vehicle.

At least one embodiment of a charge hopper assembly includes a charge hopper support having a tube structure, a bushing, and a releasable latch configured to secure a charge hopper in an engaged position. The charge hopper support is coupled to a mixer truck and the charge hopper is coupled to the charge hopper support by the releasable latch on one side of the truck and by a hinged connection on the opposite side.

Some embodiments of a charge hopper assembly include a latch mechanism having a pin, a guide, and a receiver. The latch mechanism includes a sensor and an actuator pivotally coupled to a support. When the charge hopper is open, the latch mechanism is in a first position and the sensor may provide a sensor signal (e.g., a lack of an object in proximity to the sensor) indicating that the latch is open and the hopper is not secured. According to an alternative embodiment, the sensor is a proximity switch that completes an electrical circuit (e.g., to turn on a “hopper closed and secured” light within the cab of the concrete mixer truck) when the hopper is in a closed position. In some embodiments, the proximity switch turns on a green light to visually indicate to an operator that the latch and the charge hopper are closed. In still other embodiments, the sensor may be a laser sensor, a mechanical switch, or another device. In operation, a rocker switch may be positioned in the cab to operate the various actuators of the charge hopper assembly. By way of example, an operator may actuate a rocker switch in the cab of the vehicle to rotate the latch and open the hopper. The sensor (e.g., a proximity switch, a mechanical switch, a laser sensor, a pressure switch, etc.) may provide a signal to a controller indicating that the hopper is open. In other embodiments, the sensor is included as part of an electrical circuit configured to engage a warning light when the hopper is open. When the hopper closes, the sensor may interface with a pin coupled to the hopper and provide an indication that the hopper is closed (e.g., a signal, complete an electrical circuit, etc.). In order to release the hopper such that it may rotate into an open position, an actuator for the latch mechanism is activated, which rotates a latch plate and releases the pin. The actuator for the latch and the actuator that rotates the hopper are engaged by the same switch, according to an exemplary embodiment. In other embodiments, a first switch is provided for the actuator that operates the latch mechanism and a second switch is provided for the actuator that controls the hopper.

In some embodiments, the sensor for the latch mechanism may have a plurality of electrical connections. In some embodiments, the sensor completes a circuit and turns on a light in the cab. The sensor may alternatively otherwise indicate the position of the latch mechanism and the charge hopper to an operator (e.g., with a display, etc.). According to an exemplary embodiment, the sensor interfaces with a control system that limits the gear ratio selectable by the driver (e.g., to a low-range gear) based on the position of the latch mechanism and the charge hopper. By way of example, an operator may not be able to select high gears when the latch mechanism and the charge hopper are oriented in an ‘open’ position. In some embodiments, a pair of sensors may be provided, one that senses the orientation of the latch and one that senses the orientation of the charge hopper.

Referring to the exemplary embodiment shown in FIG. 1, a concrete mixer truck 10 is a front discharge concrete mixer truck configured to mix, transport and pour concrete. The concrete mixer truck 10 includes a chassis 12, a mixing drum 14, a pedestal 16, wheels 24, and a cab enclosure 18. The chassis 12 supports the mixing drum 14, the pedestal 16, the cab enclosure 18 and engine, transmission and hydraulic systems (not shown) of the concrete mixer truck 10. The chassis 12 includes a frame 22 that extends from a rear end 28 to a front end 30 of the concrete mixer truck 10 and is coupled to wheels 24. The frame 22 provides a structural base for supporting the mixing drum 14, the pedestal 16, and the cab 18. The frame 22 includes a widened front portion that extends over and about the forward wheels 24 to simultaneously support the cab enclosure 18 and to serve as a fender for the forward wheels 24. A charge hopper assembly is positioned at an opening of the mixing drum.

Referring again to FIG. 1, the wheels 24 moveably support the frame 22 above a ground or road. As will be appreciated, the wheels 24 may be replaced by other ground engaging motive members, such as tracks. The mixing drum 14 is supported by and rotatably coupled to the frame 22 of chassis 12. The mixing drum 14 has a first end 36 towards the rear end 28 of the concrete mixer truck 10, and a second end 38 towards the front end 30 of the concrete mixer truck 10. The second end 38 extends above cab enclosure 18 and includes an opening through which concrete flows (e.g., between the charge hopper 40, the mixing drum 14, the discharge hopper 41, a main chute 44, and extension chutes 45). The mixing drum 14 is rotated in a conventionally known manner to mix concrete until being emptied. A charge hopper assembly includes the charge hopper 40 having a rim 42. As shown in FIG. 1, the charge hopper 40 is disposed at an opening of the mixing drum 14.

As shown in FIG. 1, the discharge hopper 41, charge hopper 40, and main chute 44 extend above cab enclosure 18 and forward front end 30 of concrete mixer truck 10. Pedestal 16 (i.e. a support post, support column, etc.) includes part of a superstructure of the concrete mixer truck 10 and extends between the frame 22 of the chassis 12 and the second end 38 of mixing drum 14. The superstructure further includes the frame 22 and the chassis 12. The pedestal 16 supports the second end 38 of the mixing drum 14 above the cab enclosure 18. The cab enclosure 18 includes a housing 46 supported by the frame 22 of the chassis 12 below the second end 38 of the mixing drum 14. A switch 11 is disposed within the cab enclosure 18 (e.g., in a forward overhead position) such that an occupant of the cab enclosure 18 can toggle the switch 11 from a ‘Close’ position to an ‘Open’ position.

Referring to the exemplary embodiment shown in FIGS. 2-9, the charge hopper assembly including charge hopper 40 is shown in various positions. The mixing drum 14 is rotatably coupled to the chassis of a concrete mixer truck. A platform 54 having a perforated surface surrounds the charge hopper assembly. In some embodiments, the platform 54 includes an asymmetric base. The platform includes platform sides 52 extending beneath the perforated surface. A guardrail 50 is coupled to the platform 54 and follows the contour of platform sides 52.

Referring to FIG. 2, the charge hopper 40 is coupled to a first support plate 60 and a second support plate 62. The first support plate 60 is disposed on a first lateral side of the charge hopper 40, and the second support plate 62 is disposed on a second lateral side of the charge hopper 40. As shown in FIG. 2, the second support plate 62 includes first and second apertures 72 and 74 that receive fasteners (e.g., bolts) to couple a slide block to support plate 62. The charge hopper 40 is also coupled to a support hoop 64. The support hoop 64 rotates with the support plates 60 and 62, according to an exemplary embodiment. As shown in FIG. 2, the support hoop 64 and the charge hopper 40 are rotatably coupled to a left hand hopper support tube 80 with a hinge, shown as bearing member 58.

An actuator 88 includes a rod that is sheathed in a protective boot 56. Components associated with concrete trucks and plants are exposed to impacts and abrasion from the movement of the concrete or other fluent materials and impacts from other machinery and equipment. Thus, the protective boot 56 prolongs the life of actuator 88 by protecting the rod from abrasion and impacts. As shown in FIG. 2, the actuator 88 is coupled between the first support plate 60 and the left hand hopper support tube 80. According to an exemplary embodiment, actuator 88 rotates the support hoop 64 and the charge hopper 40 about the bearing member 58 between an open position and a closed position. In some embodiments, the actuator 88 is engaged (e.g., to extend or retract) with a switch that also engages an actuator coupled to a latch mechanism of the charge hopper assembly. In some embodiments, the actuator 88 is a pneumatic device. In other embodiments, the actuator 88 is an electrical, hydraulic, electro-hydraulic, or still another type of device.

Turning now to FIG. 3, the charge hopper 40 is rotatable about bearing member 58 between an open position and a closed position. FIGS. 3-4 and 9 depict the charge hopper 40 in the open position, where the charge hopper 40 inhibits access to the opening of the drum 14 from an access point of the platform 54 (e.g., positioned at a side of the vehicle towards which the hopper is turned when in the open position). Turning the charge hopper 40 to the open position reduces the space that would otherwise be available between the discharge hopper 41 and the access point of the platform 54. In other words, although clearance between the rim 42 and the platform 54 does not change when the hopper is turned, it becomes difficult for the operator to access the opening of drum 14.

The charge hopper 40 includes a first portion that is configured to receive materials during a charging operation. The charge hopper 40 includes a second portion (i.e. chute) aligned with the bottom of the first portion. When charging, material is loaded into the first portion of the charge hopper 40 and is directed by the second portion of the charge hopper 40 into the drum 14. When discharging, discharge hopper 41 funnels material from the drum 14 into the main chute 44.

FIGS. 2 and 5-8 depict the charge hopper 40 in the closed position. In the closed position, an end of the support hoop 64 interfaces with a right hand hopper support tube 81. The hopper assembly also includes a latch 70 rotatably coupled to the right hand hopper support tube 81. The latch 70 engages a retainer, shown as pin 106, that is coupled to the support hoop 64. As shown in FIG. 4, the pin 106 is disposed on a lateral surface of the support hoop 64 between a housing 78 and a guide 94. The guide 94 aligns the support hoop 64 and pin 106 with the latch 70 and is disposed on a lower surface of the support hoop 64. Upon engaging pin 106, the latch 70 secures the charge hopper 40 in the closed position.

According to an exemplary embodiment, a sensor 82 is positioned on the latch 70. As shown in FIG. 4, the latch 70 and sensor 82 are positioned on an opposite lateral side of the vehicle than the left hand hopper support tube 80 and the bearing member 58. According to an exemplary embodiment, the sensor 82 is a proximity switch that completes an electrical circuit (e.g., to turn on a “hopper closed and secured” light within the cab of the concrete mixer truck) when the charge hopper 40 is in a closed position. In some embodiments, the proximity switch turns on a green light to visually indicate to an operator that the latch 70 and the charge hopper 40 are closed. In still other embodiments, the sensor 82 may be a laser sensor, a mechanical switch, a pressure sensor, a pressure switch, or another device. The sensor 82 may provide a signal to a controller indicating the position of the charge hopper 40 (e.g., open, closed, etc.). In other embodiments, the sensor 82 is included as part of a circuit configured to engage a warning light when the charge hopper 82 is open.

According to an exemplary embodiment, the sensor 82 indicates the position of the latch 70 and the charge hopper 40. The sensor 82 rotates with the latch 70 such that the sensor 82 may detect the presence of the pin 106 only when the latch 70 and the charge hopper 40 are rotated into their respective closed positions, according to an exemplary embodiment. By way of example, the sensor 82 may be a proximity switch that completes a circuit (e.g., to energize a “hopper closed and secured”) when the pin 106 is positioned in proximity with a sensing end of sensor 82 (e.g., when both the latch 70 and the charge hopper 40 are in their closed positions).

As shown in FIG. 4, an electrical connector 84 is coupled to sensor 82. According to an exemplary embodiment, the electrical connector 84 forms part of an electrical circuit (e.g., where sensor 82 is a proximity switch). According to an alternative embodiment, electrical connector 84 relays signals between the sensor 82 and a controller that is configured to determine the position of the charge hopper 40. As shown in FIG. 4, the electrical connector 84 is wound around right hand hopper support tube 81 thereby providing strain relief for the joint between electrical connector 84 and sensor 82.

Referring again to FIG. 4, the charge hopper assembly includes an actuator 86 having a first end coupled to the right hand hopper support tube 81 and a second end coupled to the latch 70. In some embodiments, the switch 11 is configured to engage the actuator 86 when the switch 11 is toggled into the ‘open’ position. The actuator 86 rotates the latch 70 about a pivot point between an open position and a closed position. In some embodiments, the actuator 86 is a pneumatic device. In other embodiments, the actuator 86 is an electrical, hydraulic, electro-hydraulic, or still another type of device. The guide 94 and a portion of the pin 106 shown in FIG. 4 are not visible from a front of the truck when the charge hopper 40 is in the closed position. In the closed position, the pin 106 and the guide 94 have aligned with the latch 70, and the latch 70 engages the pin 106 to secure the charge hopper 40. When the charge hopper 70 is oriented in the open position, the latch 70 is in an open position. The switch 11 may be oriented in an ‘Open’ position, and an indicator light (e.g., a ‘hopper closed and secured’ light, etc.) is deactivated (i.e. de-energized). The actuator 88 may position the charge hopper 40 (e.g., after an operator orients the switch 11 into the ‘Closed’ position, etc.) into a closed position where the pin 106 is rotated toward the latch 70 and sensor 82. According to an exemplary embodiment, the charge hopper 40 rotates to the open position from the closed position as the actuator 88 is retracted and rotates to the closed position from the open position when the actuator 88 is extended. According to an alternative embodiment, the actuator 88 is a rotational device or another type of non-linear actuator that otherwise rotates the charge hopper 40 between the open and closed positions.

According to an exemplary embodiment, the sensor 82 determines the orientation of the charge hopper 40 (e.g., a proximity switch interfaces with pin 106 to close a circuit) and provides an indication that the hopper is closed (e.g., as a signal to a controller, turns on an indicator light, etc.). Concurrently, the latch 70 engages the pin 106 and secures the charge hopper 40 in the closed position, as shown in FIG. 6. According to an exemplary embodiment, actuator 86 and actuator 88 are pneumatic devices are extended or retracted with valves opened or closed in response to the position of switch 11. According to an alternative embodiment, the sensor 82, the actuator 86, and the actuator 88 may be in communication with a controller that is coupled to switch 11. In some embodiments, the controller communicates with the sensor 82, the actuator 86, and the actuator 88 to move the hopper from the open position to the closed position. In other embodiments, the controller communicates with the sensor 82, the actuator 86, and the actuator 88 to move the hopper from the open position to the closed position upon receiving a gear ratio signal and determining that the operator has selected a gear ratio greater than a low gear. In some embodiments, the controller further communicates with an interlock mechanism of a driveline to inhibit vehicular movement (e.g., prevent movement entirely, limit movement to low vehicle speeds, etc.) when the charge hopper 40 and the latch 70 are open.

As shown in FIG. 6, the charge hopper 40 in the closed position. The guide 94 shown in FIG. 4 is not visible from a lateral side of the truck, which is shown in FIG. 6, when the charge hopper 40 is in the closed position. According to the exemplary embodiment shown in FIG. 6, the rim 42 is disposed above a platform bordered by platform sides 52. The distance between the rim 42 and the platform sides 52 remains constant irrespective of whether the hopper is in a closed or open position. It can be appreciated from FIGS. 2, 3, and 6 that the overall height of the vehicle does not change as the charge hopper 40 rotates between the first position and the second position. That is, the vertical clearance of a truck with such a charge hopper assembly is not diminished by the charge hopper 40, irrespective of the position or movement of the charge hopper 40. Such a constant vehicle height may reduce the likelihood of damage to concrete charging stations, which may include doors, siding, or other structures positioned at a fixed height.

It is important to note that the construction and arrangement of the elements of the systems as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited herein. For example, elements shown as integrally formed may be constructed of multiple parts or elements. The position of elements may be reversed or otherwise varied, and the nature or number of discrete elements or positions may be altered or varied. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present invention. The order or sequence of any process, logical algorithm, or method steps may be varied or re-sequenced according to alternative embodiments. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A concrete mixer, comprising:
a chassis;
a cab coupled to the chassis;
a mixing drum rotatably coupled to the chassis and defining an opening; and
a charge hopper assembly positioned at the opening of the mixing drum and comprising:
a latch,
an actuator coupled to the latch and positioned to move the latch between a first position and a second position, and
a sensor positioned on the latch and configured to indicate the orientation of the latch and the charge hopper assembly.

2. The concrete mixer of claim 1, wherein the cab includes a switch that engages the actuator.

3. The concrete mixer of claim 2, wherein engagement of the actuator moves the latch into the second position such that the charge hopper assembly may rotate away from the mixing drum.

4. The concrete mixer of claim 3, wherein the charge hopper assembly comprises a first portion for receiving materials and a second portion including a chute aligned with the bottom of the first portion when the charge hopper assembly is configured in a charging position, the chute configured to direct material received by the first portion into the mixing drum.

5. The concrete mixer of claim 4, wherein the actuator retracts to move the latch from the first position to the second position and wherein the actuator extends to move the latch from the second position to the first position.

6. The concrete mixer of claim 4, wherein the charge hopper assembly rotates about a pivot towards an operator access point on a side of concrete mixer to inhibit access to the opening of the mixing drum during operation.

7. The concrete mixer of claim 6, wherein rotating the charge hopper assembly to the side of the concrete mixer does not reduce a clearance height above the concrete mixer and does not increase the height of the concrete mixer.

8. The concrete mixer of claim 7, wherein the switch closes the first portion of the charge hopper assembly when an object is detected to be in a position that exceeds a predetermined proximity position or when a gear ratio of the concrete mixer is detected to exceed a predetermined gear ratio.

9. A charge hopper assembly for a vehicle having a platform, comprising:
a first support member coupled to a first lateral side of the platform;
a second support member coupled to a second lateral side of the platform;
a hopper coupled to the first support member and configured to direct material into a mixing drum;
a latch coupled to the second support member and movable between a first position and second position, wherein the latch secures the hopper to the second support member when in the second position;
an actuator coupled to the latch and configured to move the latch between the first position and the second position; and
a sensor positioned on the latch and configured to indicate the orientation of the latch and the charge hopper assembly;
wherein the charge hopper assembly rotates to a side of the platform such that the charge hopper assembly inhibits access to an opening of the mixing drum.

10. The charge hopper assembly of claim 9, wherein the actuator is configured to be actuated by a switch such that the charge hopper assembly rotates to the side of the platform when an object is detected to be in a position that exceeds a predetermined proximity position.

11. The charge hopper assembly of claim 9, wherein the actuator is configured to be actuated by a switch such that the charge hopper assembly rotates to the side of the platform when a gear ratio of the vehicle is detected to exceed a predetermined gear ratio.

12. The charge hopper assembly of claim 9, wherein retraction of the actuator moves the charge hopper assembly from a first position to a second position and wherein extension of the actuator moves the charge hopper assembly from the second position to the first position.

13. The charge hopper assembly of claim 12, wherein the vehicle is a front discharge concrete mixer.

14. The charge hopper assembly of claim 12, wherein the vehicle is a rear discharge concrete mixer.

15. The charge hopper assembly of claim 12, wherein the actuator includes a rod sheathed in a protective boot.

16. The charge hopper assembly of claim 15, wherein the actuator is a pneumatic cylinder.

17. The charge hopper assembly of claim 15, wherein the actuator is at least one of a hydraulic cylinder, an electrical actuator, and an electro-hydraulic actuator.

18. A superstructure for a concrete truck, comprising:
a support configured to be coupled to a first lateral side of the concrete truck that provides operator access; and
a charge hopper assembly coupled to the support, the charge hopper assembly comprising:
a first support member coupled to the first lateral side of the support;
a second support member coupled to an opposing lateral side of the support; and
a charging chute for receiving materials,
wherein the charging chute is rotatably coupled to the first support member with a pivot such that the charging chute rotates toward the first lateral side of the concrete truck.

19. The superstructure of claim 18, wherein the charge hopper assembly further comprises an actuator pivotally coupled between the support and the concrete truck, the actuator permitting movement of the support and the charging chute away from a mixing drum, and wherein the charge hopper assembly swings to a side of the concrete truck to inhibit access to an opening of the mixing drum during operation.

20. The superstructure of claim 19, wherein retraction of the actuator moves the charge hopper assembly from a first position to a second position and wherein extension of the actuator moves the charge hopper assembly from the second position to the first position.
